(19) United States
(12) Patent Application Publication
(10) Pub. No.: US 2024/0003763 A1
(43) Pub. Date: Jan. 4, 2024

(54) HELICAL OPTICAL FIBERS FOR STRAIN MEASUREMENT

(71) Applicant: ARAMCO SERVICES COMPANY, Houston, TX (US)

(72) Inventors: Seth Busetti, Houston, TX (US); Harold Merry, Houston, TX (US)

(73) Assignee: ARAMCO SERVICES COMPANY, Houston, TX (US)

(21) Appl. No.: 17/854,926

(22) Filed: Jun. 30, 2022

(51) Int. Cl. G01L 1/24

(52) U.S. Cl. CPC G01L 1/242

(57) ABSTRACT

A method for measuring a strain field involves determining an expected source mechanism of the strain field, based on the expected source mechanism, estimating strain field tensors of the strain field in an area of interest, determining principal strain vectors from the strain field tensors, identifying the most extensional principal strain vectors, ε₃, from the principal strain vectors, establishing a trajectory of a fiber optic path through the area of interest, discretizing the fiber optic path to obtain directions of fiber axial strain, εₐ, comparing εₐ against ε₃, and based on the comparison, optimizing the fiber optic path for an alignment of εₐ with ε₃.

### BACKGROUND

Distributed fiber optic sensing (DFOS) using fiber optic networks may be used to detect strain in the subsurface. The strain may be due to a range of natural and operational sources. For example, surface-based ground motions, hydraulic fracturing, earthquakes, subsidence, reservoir flow, wellbore operations, thermal expansion and contraction, and seismic wave propagation may be causes for strain.

Most DFOS applications focus on high-frequency bands (>1 Hz), which convey information about sources such as seismic wave transmission. For geological deformation, i.e., quasi-static strain, the low-frequency band (<0.05 Hz) provides more information.

In fiber optic-based strain deployments it is common to assume sufficient alignment between the acting strain field and the extension axis of fiber to resolve the strain patterns. However, this assumption is not necessarily reasonable. Accordingly, it may be desirable to optimize the orientation of the fiber to improve resolution of the three-dimensional characteristics of strain fields recorded in DFOS applications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for measuring a strain field, the method comprising: determining an expected source mechanism of the strain field; based on the expected source mechanism, estimating strain field tensors of the strain field in an area of interest; determining principal strain vectors from the strain field tensors; identifying the most extensional principal strain vectors, ε₃, from the principal strain vectors; establishing a trajectory of a fiber optic path through the area of interest; discretizing the fiber optic path to obtain directions of fiber axial strain, εₐ; comparing εₐ against ε₃; and based on the comparison, optimizing the fiber optic path for an alignment of εₐ with ε₃.

In general, in one aspect, embodiments relate to a system for measuring a strain field, the system comprising: a computer system configured to: determine an expected source mechanism of the strain field; based on the expected source mechanism, estimate strain field tensors of the strain field in an area of interest; determine principal strain vectors from the strain field tensors; identify the most extensional principal strain vectors, ε₃, from the principal strain vectors; establish a trajectory of a fiber optic path through the area of interest; discretize the fiber optic path to obtain directions of fiber axial strain, εₐ; compare εₐ against ε₃; and based on the comparison, optimize the fiber optic path for an alignment of εₐ with ε₃.

In general, in one aspect, embodiments relate to a non-transitory machine-readable medium comprising a plurality of machine-readable instructions executed by one or more processors, the plurality of machine-readable instructions causing the one or more processors to perform operations comprising: determining an expected source mechanism of a strain field; based on the expected source mechanism, estimating strain field tensors of the strain field in an area of interest; determining principal strain vectors from the strain field tensors; identifying the most extensional principal strain vectors, ε₃, from the principal strain vectors; establishing a trajectory of a fiber optic path through the area of interest; discretizing the fiber optic path to obtain directions of fiber axial strain, εₐ; comparing εₐ against ε₃; and based on the comparison, optimizing the fiber optic path for an alignment of εₐ with ε₃.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a wellbore scenario, in accordance with one or more embodiments.

FIG. 2 shows a fiber optic sensing system, in accordance with one or more embodiments.

FIG. 3A schematically shows a wellbore instrumented with a linear fiber, in accordance with one or more embodiments.

FIG. 3B illustrates the detection of an external load using a linear fiber, in accordance with one or more embodiments.

FIG. 3C schematically shows a projection of a strain vector onto a linear fiber, in accordance with one or more embodiments.

FIG. 4A shows a unit cube with incremental displacements and strains, in accordance with one or more embodiments.

FIG. 4B shows a strain field represented by histograms, in accordance with one or more embodiments.

FIG. 4C shows a strain field represented by stereonets, in accordance with one or more embodiments.

FIG. 5A shows a helical fiber optic sensing system, in accordance with one or more embodiments.

FIG. 5B shows a contra-helical fiber optic sensing system, in accordance with one or more embodiments.

FIG. 5C shows a multifiber contra-helical fiber optic sensing system, in accordance with one or more embodiments.

FIG. 6A shows contra-helical fiber optic systems in stereonet plots, in accordance with one or more embodiments.

FIG. 6B shows axial strain orientation coverage of contra-helical fiber optic systems, in accordance with one or more embodiments.

FIG. 6C shows strain field vectors vs fiber direction vectors, in accordance with one or more embodiments.

FIG. 7 shows a flowchart of a method for strain measurement, in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods that involve optical fibers for strain measurement. Embodiments of the disclosure detect static of quasi static strain such as strain generated from quasi-static geologic deformation.

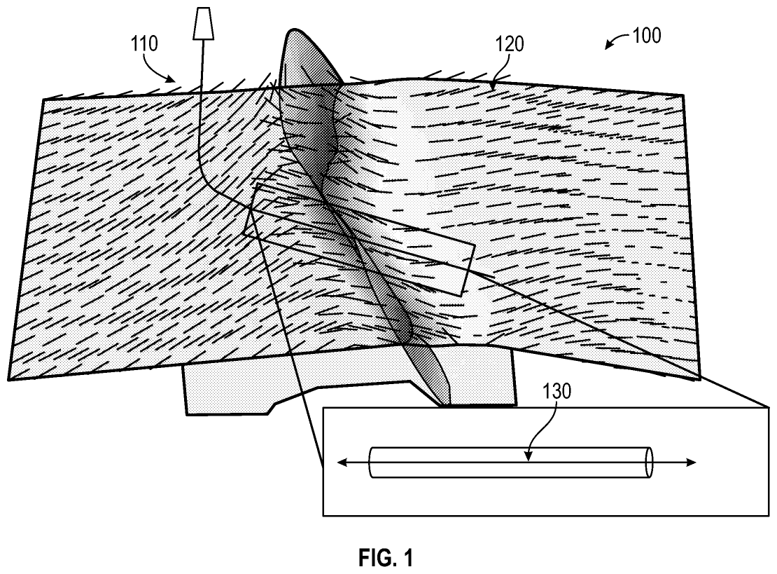

FIG. 1 shows a wellbore scenario in which a strain field surrounds a wellbore. The wellbore scenario (100) is intended to serve as an example for the sensing of strain fields; therefore, embodiments of the disclosure are not limited to the scenario (100). In the scenario (100), a wellbore (110) extends from the surface into a target zone of a hydrocarbon-bearing formation, such as the reservoir. A strain field (120) surrounds the wellbore (110). In the example, the strain field (120) is a result of geological deformation, and the three-dimensional strain field (120) is highly non-homogeneous. A fiber (130) may be used to sense the strain field (120). In one or more embodiments, a winding pattern of the fiber (130), e.g., a helical winding pattern, is optimized to improve geomechanical measurement of the three-dimensional strain field (120). For example, the orientation of the fiber in the winding pattern may be optimized to improve resolution of the three-dimensional characteristics of the strain fields (120).

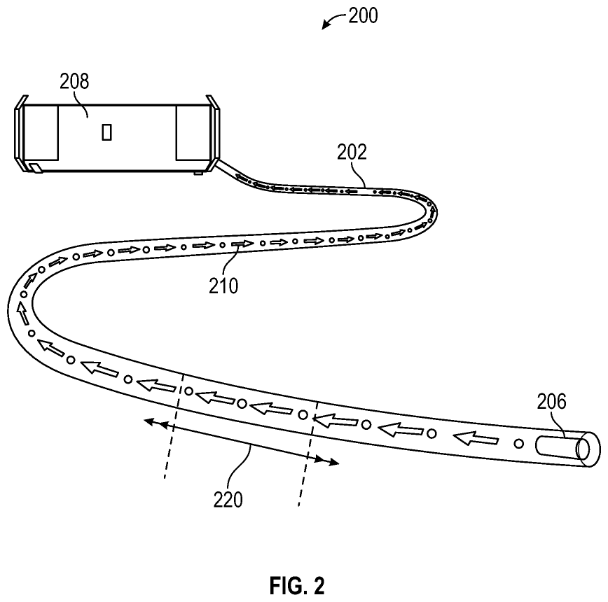

FIG. 2 shows a fiber optic sensing system, in accordance with one or more embodiments. The fiber optic sensing system (200) may be used to sense the strain field (120) introduced in FIG. 1. The fiber optic sensing system (200) uses fiber optic cable or fiber (202) to collect mechanical strain data along the cable. The fiber (202) is interrogated by a light source (e.g., a laser). An interrogator unit (208) sends pulses of light (206) down the fiber (202). A small amount of the light is backscattered to the interrogator unit (208) from microheterogeneities naturally present in the fiber (202). The strain field (120) may disturb the fiber (202). For example, a perturbation in the environment surrounding the fiber (202) may result in strain (220), i.e., an elongation (220) of the fiber (202) in an axial direction, thereby causing a variation in the backscatter (210). The backscatter (210) may be analyzed and interpreted to turn light information back into information about the strain field (120). Specifically, the interrogator unit (208) may measure the changes in the backscatter (210) (amplitude, delay, and/or phase, etc.) caused by the strain (220). There may be various causes for the strain (220). For example, a propagating seismic wave, a mechanical, thermal, or hydraulic strain in the environment surrounding the fiber (202) may cause the strain (220) in the fiber, resulting in a change of the travel time of the pulse light (206).

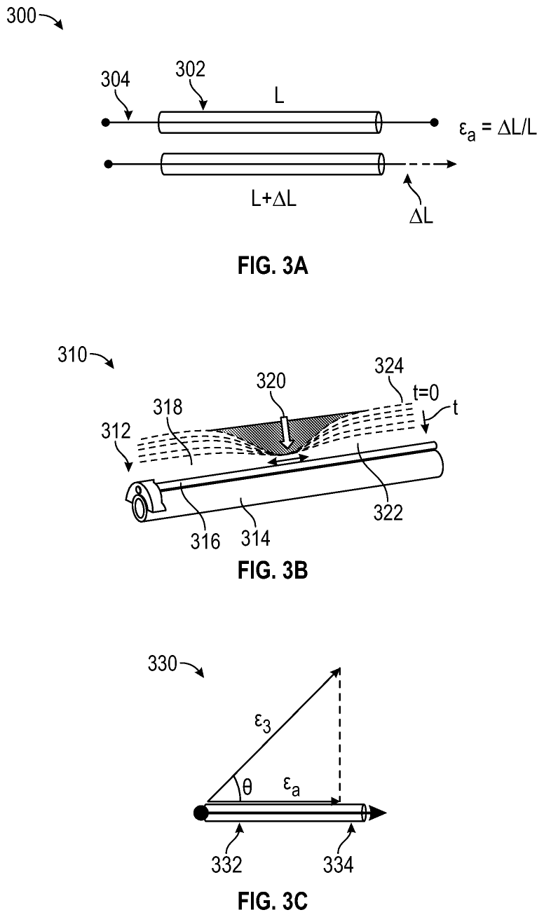

In the following discussion, referring to FIGS. 3A, 3B, and 3C, general concepts of the fiber-based sensing of strain are introduced. This is followed by a more specific discussion of the use of helically arranged fibers for the sensing of strain, in accordance with one or more embodiments.

FIG. 3A schematically shows a wellbore instrumented with a linear fiber, in accordance with one or more embodiments. The fiber (304) is parallel to the wellbore (402). In the absence of strain, the fiber (or an interval of the fiber) has a length, L. In the presence of a perturbation, the fiber (304) experiences strain. In other words, the length of the fiber (304) changes by an amount ΔL. The ratio εₐ=ΔL/L is the resulting axial strain of the fiber.

FIG. 3B illustrates the detection of an external load using a linear fiber, in accordance with one or more embodiments. The fiber (316) is part of a wellbore (312) that includes a casing (314) enclosed in cement (318). The fiber (316) may be in the cement (318). In the scenario (310) illustrating the detection of an external load using a linear fiber, the external load (320) is detected in the fiber (316) as a projection of 1D axial strain (322). The intensity of strain is visualized along the fiber length as a function of time (“waterfall plot”). As FIG. 3B illustrates, the strain distribution (324), thus, has a spatial and a temporal component.

FIG. 3C schematically shows a projection of a strain vector onto a linear fiber, in accordance with one or more embodiments. The projection of ε3 (one of the principal strains (ε₁, ε₂, ε₃), discussed below, on Ea in the axial direction of the fiber is solved by trigonometry:

|εₐ|=|ε₃|cos θ, [1]

where θ is the angle between the two vectors and straight brackets denote vector magnitude.

For a three-dimensional vector, the vector magnitude is calculated from the vector directional components:

|ν|=\sqrt{x²+y²+z²}. [2]

The unit vector is defined as:

$$\hat{v} = \frac{v}{\vert v \vert} . \qquad [ 3 ]$$

The angle θ may be determined using the dot product relationship:

$$cos θ = \frac{{ε}_{3} \cdot {ε}_{a}}{\vert {ε}_{3} \vert \vert {ε}_{a} \vert} . \qquad [ 4 ]$$

By substituting the unit vectors for the direction of the fiber axis [symbol] and [symbol] the equation simplifies to:

θ=cos⁻¹( [symbol] · [symbol] ). [5]

The axial strain on the fiber is most sensitive to the extension mode of deformation, which is a function of vector orientation that reaches its maxima in the direction of the most positive component, which by common convention is the minimum principal strain vector ε₃ in the subsurface. In other configurations where all the principal strain vectors are positive such as under volumetric expansion the maximum extension vector could also be the maximum principal strain εₜ. In other configurations, strain in the fiber may be recorded as relative extension or contraction, which is represented by strain change Δε or strain rate dε/dt. When fiber axial strain is perfectly aligned with the most extensional principal strain, εₐ=ε₃. In such cases no optimization is needed because the fiber direction is oriented favorably to detect the external strain field (FIGS. 3A and 3B). For misaligned or heterogeneous strain fields, such as shown in FIG. 1, the fiber axis strain needs to be corrected, as shown in FIG. 3C.

As previously discussed, strain fields as the one shown in FIG. 1 may be heterogeneous. In the example of FIG. 1, the three-dimensional strain field shows the minimum principal strain (most extensional) vectors, with the well path intersecting the strain field. As FIG. 1 illustrates, the strain field is spatially highly irregular with the axial strain direction of the fiber being misaligned with the field strain vectors. A more detailed discussion of strain is subsequently provided.

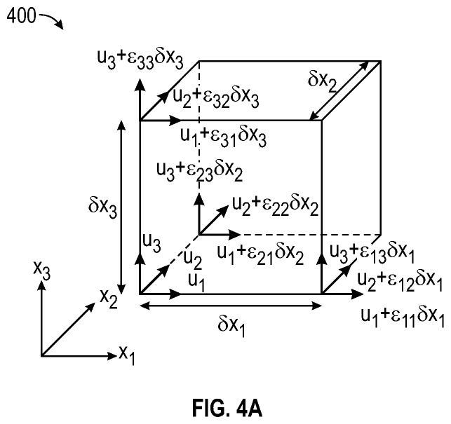

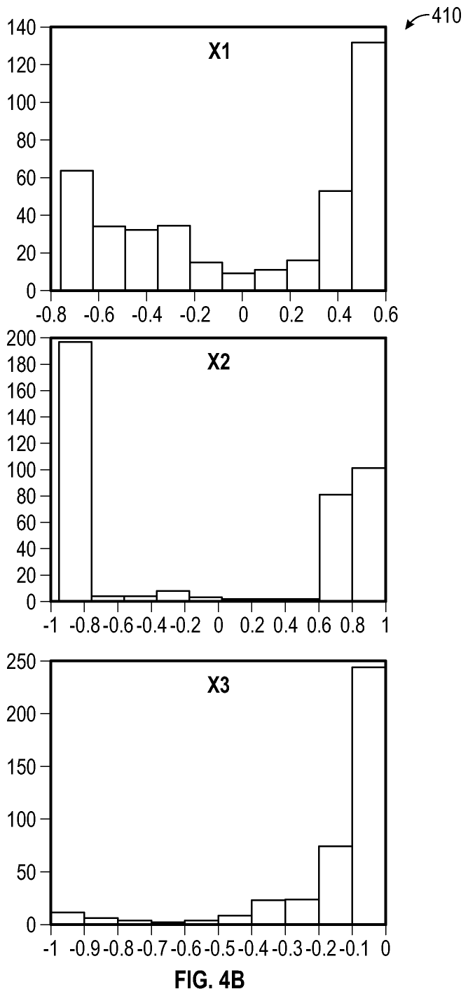

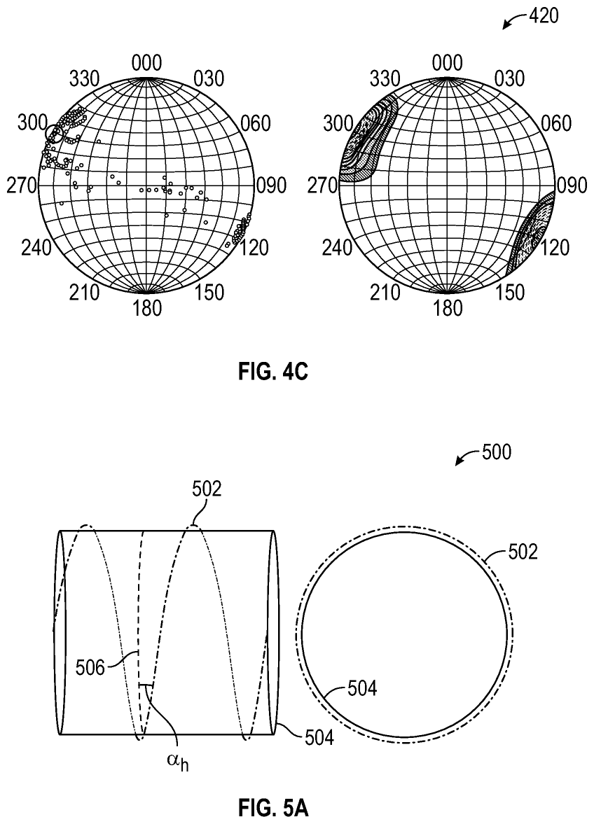

FIG. 4A shows a unit cube with incremental displacements and strain in three directions, in accordance with one or more embodiments. In the unit cube (400), the strain tensor s, is a symmetric second order nine component tensor:

$${ε}_{ij} = [ \begin{matrix}{ε}_{11} & {ε}_{12} & {ε}_{13} \\ {ε}_{21} & {ε}_{22} & {ε}_{23} \\ {ε}_{31} & {ε}_{32} & {ε}_{33}\end{matrix} ] , \qquad [ 6 ]$$

where ε₂₁=ε₁₂, ε₃₁=ε₁₃, and ε₃₁=ε₁₃. Each component of the strain tensor represents a displacement of one face of the cube in a particular direction. For example, ε₁₂ represents the displacement in the 2-direction of the face of the cube normal to the 1-direction. Similarly, ε₃₂ represents the displacement in the 2-direction of the face of the cube normal to the 3-direction. The tensor εᵢⱼ describes a particular coordinate system that may be denoted (x₁, x₂, x₃). The coordinate system may be an orthonormal coordinate system. The value of any element of the strain tensor, ε, such as ε₁₂ will depend on the coordinate system chosen. However, it is always possible to find a principal coordinate system such that the strain tensor, ε, is diagonal:

$$ε = [ \begin{matrix}{ε}_{1} & 0 & 0 \\ 0 & {ε}_{2} & 0 \\ 0 & 0 & {ε}_{3}\end{matrix} ] , \qquad [ 7 ]$$

where ε₁, ε₂, and ε₃ are called principal strains or eigenvalues and the axes of this principal coordinate system are called the principal strain directions or eigenvectors and may be denoted η₁, η₂, and η₃. In this system contractional strain directed inward on the face of a unit volume cube is given a negative sign. Extensional strain directed outward on the face of a unit volume is given a positive sign.

In a three-dimensional strain field, the three-dimensional strain field may be simplified to a representative strain vector, for example the mean, median, or mode ε₃ vector. Alternatively, multiple strain vectors comprising the strain field may be considered, such that the i-th term of ε₃ⁱ represents a 4D geospatial dependency ε₃ⁱ=f(xᵢ, yᵢ, zᵢ, t).

For example, at time t, an evolving strain field may be represented by n strain vectors, the unit strain vectors [symbol] can be represented statistically by three histograms, one for each vector direction component (x₁, x₂, x₃), or as a stereonet.

FIG. 4B provides an example of a strain field represented by n strain vectors in the form of histograms (410). Three histograms representing the most extensional principal unit strain vector [symbol] components (x₁, x₂, x₃) for a simulated strain field are shown. In the histograms, the X-axis indicates unit vector component magnitude, and the Y-axis is for the binned number of points.

FIG. 4C provides an example of a strain field represented by n strain vectors in the form of stereonets (420). In the stereonets the orientation of the most extensional principal unit strain vector [symbol] for a heterogeneous three-dimensional strain field are shown. In the left stereonet, individual vectors are indicated using dots, [symbol] and a mean [symbol] is indicated by a circle. In the right stereonet, a contour density plot represents the [symbol] vectors.

A uniform strain field would plot on the stereonet as a single dot representing a single vector. In previous fiber optic applications, the external or acting strain field may have been imagined as a single vector coinciding with the presumed axial strain, which is an extension along the constant fiber direction: εₐ≈ε₃≈εᵢᵢ=f(t).

For a uniform strain field, a fiber that is aligned in a linear pattern with the wellbore direction may be used. Several installation methods are common. For example, in a permanent installation, a fiber-optic cable may be cemented behind casing (e.g., as shown in FIG. 3B). In semi-permanent configurations the fiber may be between the tubing and the casing, whereas in-well intervention setups, the fiber may be conveyed in tubing, embedded in a wireline, or via a centralized rod. In some surface configurations there may be a concrete pad and a permanent installation where the fiber-optic cable is attached outside the casing and in direct contact with the cement so that deflections of the cement are directly coupled to the length of the fiber. For linear fiber paths (no winding) the fiber axial strain direction is constant relative to the cartesian coordinates.

However, the shape and magnitude of stress perturbations around structural discontinuities such as faults or hydraulic fractures can be quite complex. In the presence of a more complex strain field the axial extension direction of the fiber may be misaligned with the minimum principal strain vectors of the three-dimensional strain field (e.g., as shown in FIG. 1). In this case, the fiber may be wrapped around the well, casing, or tubing in a helical or cork-screw pattern to improve resolution of such more complex strain fields.

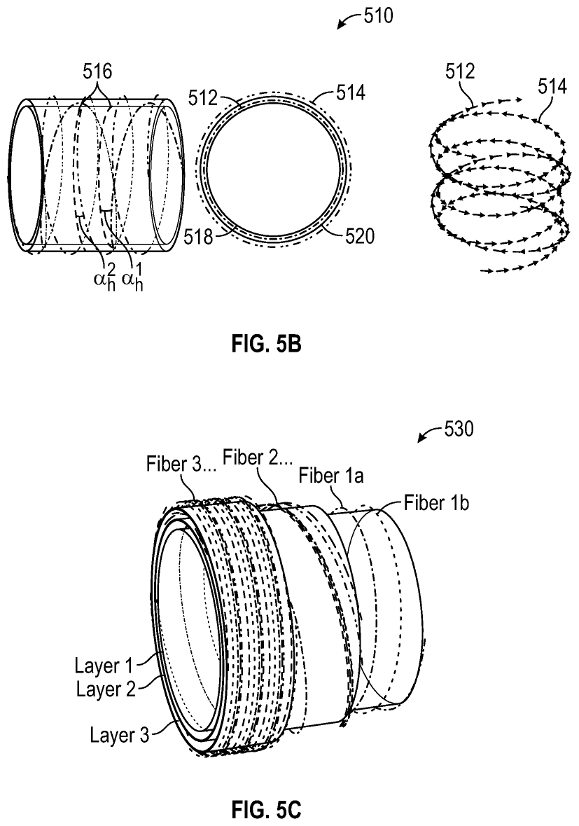

FIG. 5A shows a schematic for a helical fiber optic sensing system in accordance with one or more embodiments. The helical fiber optic sensing system (500) includes a fiber (502) wrapped helically with a wrap angle of ah around a liner or sheath layer (504) having a central axis. In the representation, ah reflects the true inclination angle of the fiber (502) relative to the normal transection (506) of the wellbore cylinder as the fiber (502) revolves around the wellbore cylinder.

FIG. 5B shows a schematic for a contra-helical fiber optic sensing system in accordance with one or more embodiments. A contra-helical fiber optic sensing system (510) with a contra-helical fiber winding may be created by wrapping a second fiber (514) in the reverse direction of the first fiber (512). Commonly a second liner or sheath layer (520) is added in addition to the first liner or sheath layer (518) to separate the cylindrical layers. The wrap angle can be the same or different from the first fiber, αₕⁱ, where i is the fiber number.

FIG. 5C shows a three-layered multifiber contra-helical fiber optic sensing system in accordance with one or more embodiments. A multifiber contra-helical fiber optic sensing system (530), as illustrated in FIG. 5C, may have multiple fibers per layer and layers of fiber with differing orientations.

As previously noted, the ability of a fiber to detect a source signal is a function of the source type and the associated strain tensor and orientation, e.g., incidence angle of a propagating wave in high frequency DAS sensing. For linear arrays where the fiber path is parallel to the wellbore axis, the sensitivity of the fiber is maximized. However, for “broadside” signals where the p-wave propagates normal to the wellbore and the fiber path there is a loss of sensitivity and the signal may not be detected. For helically wound fiber paths as shown in FIGS. 5A, 5B, and 5C, a sensitivity term may be used to account for the helically wound fiber paths that spirally wrap around the wellbore axis. In DAS sensing, the helically wound fiber path enables the capturing of broadside seismic wave signals without significant signal loss, since a propagating p-wave normal to the wellbore would not be normal to a helical fiber path. The helical fiber angular sensitivity S projecting wave strain along the fiber axis is given as a function of incidence angle θ and fiber wrapping angle α:

$$S = {cos}^{2} θ {sin}^{2} θα + \frac{{sin}^{2} θ {cos}^{2} θα}{2} , \qquad [ 8 ]$$

where α=90° reflects a linear fiber path (non-helical) and α=35° gives a value of S=1/3 which corresponds to no dependence of S on θ. This sensitivity function for wave incidence angle (high frequency DAS) is analogous to the 9 component strain tensor alignment considered for quasi-static strain (low frequency DAS). In both cases, multiple fibers with different wrap angles can be constructed to provide an overall fiber network response with improved fiber angle sensitivity or strain tensor alignment, e.g., as shown in FIGS. 5B and 5C.

When using optical fibers as strain sensors, a strain-induced change in optical properties may occur due to differential changes in the backscattered light that transmits within the fiber. In the Rayleigh backscattering method a strain-induced wavelength λ_{i,ε}(i=n) shift relates to optical phase changes and may be computed as a function of axial strain change Δε such that corresponding wavelength dips shift linearly when axial strain increases. For example, in one published multicore structure study, the λₗ component strain-induced wavelength shift is approximated by:

$${Δλ}_{1 , ε} \approx \frac{2}{2 m + 1} ( \frac{\partial {n}_{eff}^{c}}{\partial ε} - \frac{\partial {n}_{eff}^{cl}}{\partial ε} + {n}_{eff}^{ou} - {n}_{eff}^{cl} ) L Δε , \qquad [ 9 ]$$

where L is the length of the multicore fiber, n_{eff}^{ou}, n_{eff}^{ce}, and n_{eff}^{cl} are the refractive indices of the outer core, center core, and cladding modes. The external axial strain term Δε is defined as the change in length of the whole multicore fiber and center core, Δε=ΔL/L=ΔLH/LH. According to this formulation, axial strain variations along the fiber affect light transmission, but there is no reconciliation of axial strain in the local fiber coordinates and the strain field imposed on the fiber from an external source. Other examples based on optical phase changes as well as Brillouin frequency shift approaches show similar dependency between optically derived strain and imposed axial strain. In other words, axial strain along the fiber is assumed to a function of a simplified 1D fiber extension, not resolved from a three-dimensional strain source such as created from geologic deformation.

For the helical and contra-helical fiber optic systems as shown in the examples of FIGS. 5A, 5B, and 5C, the fiber orientation is not constant but is defined by a spiraling vector path, which is sometimes referred to by the fiber tangent directions. As illustrated in FIG. 5B (right panel), the fiber path may be discretized in order to quantify the orientation relative to the global coordinate system in terms of unit vectors. Each of the unit vectors may represent a fiber tangential direction, averaged over the gauge length of the fiber used in the fiber optic sensing system. In other words, the unit vector does not represent a point measurement, and an appropriate spatial averaging may thus need to be applied to fiber strain results that are obtained using the described fiber optic systems. A helical winding may maintain a constant wrap angle, resulting in a constant inclination for a vertical well. Non-uniform wrap angles may be used, without departing from the disclosure. Populations of orientation vectors may be represented statistically by histograms or stereonets. For example, vector orientation may be represented in terms of trend and plunge. If the wellbore axis is vertical, for a single helical wrap with constant wrap inclination, the fiber trend covers the full range of azimuths from 0° to 360° and plunge is constant.

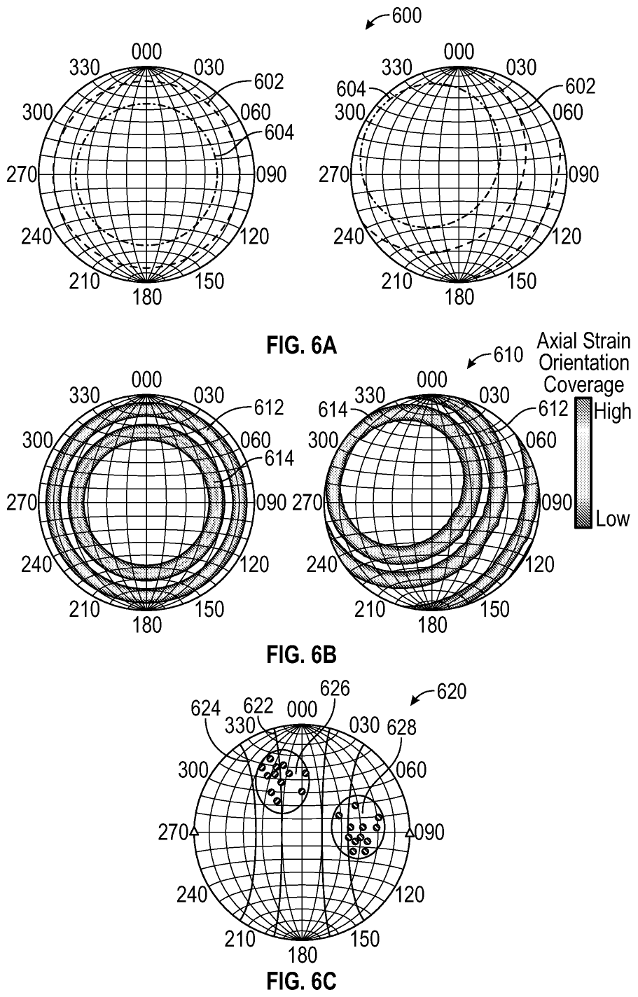

FIG. 6A shows stereonet plots of contra-helical fiber optic systems, in accordance with one or more embodiments. In the stereonet plots (600), the population of vectors forms a circle, reflecting the full range of azimuths. Contra-helical patterns with a different wrap inclination produce circles with different diameters (fiber 1 (602), fiber 2 (604)). For deviated wells the trend and plunge vectors are rotated, thus appearing on a stereonet as shifted circles or great circles or arcs, as illustrated in the right panel of FIG. 6A.

In one or more embodiments, the three-dimensional fiber orientation vectors correspond to the fiber axial strain direction that can best be resolved by the fiber optic network.

FIG. 6B shows a contour display on stereonet plots showing axial strain orientation coverage for a contra-helical fiber optic system (610). The stereonet plots (610) are generated for two different scenarios, both with two fibers (612, 614). The two scenarios may correspond to the two scenarios shown in FIG. 6A. Warm colors indicate orientations most suitable for detecting axial strain along the fiber. Based on the optimal coverage as shown in FIG. 6B, required correction factors (equations 1-5) may be determined depending on where strain is actually measured. Specifically, for orientations where the external ε₃ strain vector field (FIG. 4C) aligns with the axial strain orientation coverage map (FIG. 6B) the fiber orientation is optimized to detect strain. Mismatches between the external strain vector field (FIG. 4C) and axial strain orientation coverage (FIG. 6B) indicate orientations that are not optimized for detecting strain, thus requiring correction (equations 1-5).

FIG. 6C shows a stereonet plot (620) comparing external ε₃ strain vector fields (626, 628) and fiber direction vectors (622, 624). In the example, the well is horizontal and is oriented in an east-west direction, and fiber optic system follows the well in this direction. A contra-helical fiber optic system with two fibers (622, 624) is shown. Points indicate most extensional principal strain ε₃ vector orientations from two different external strain fields, A (626) and B (628), as derived from field data, numerical simulations, etc. In the stereonet plot (620), fiber 1 (622) tangent directions are well oriented to detect axial strain contributions coming from strain field A (626). Fiber 2 (624) is optimized to detect strain field B (628). In contrast, a linear fiber path (straight east-west) would be misaligned with both strain fields.

As the example of FIG. 6C illustrates, different strain fields require different fiber configuration for reliable measurement of the strain field. In one or more embodiments, optimizations of the fiber(s) are performed to increase the likeliness that one or more strain fields can be reliably evaluated. The subsequently described method may be used to perform the optimization.

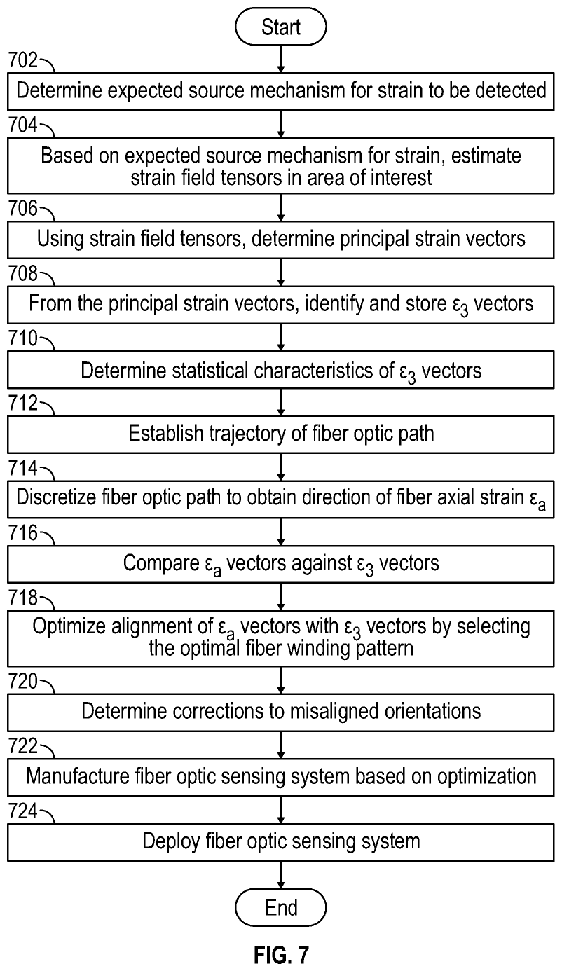

FIG. 7, shows a flowchart in accordance with one or more embodiments. The flowchart describes a method (700) for obtaining strain measurements using optical fibers. The method (700) includes steps for optimizing a fiber pattern to improve resolution of the strain field using low-frequency distributed acoustic sensing (DAS) data. Briefly summarized, the method accommodates different optimization scenarios.

For example, if a linear fiber array is used, recorded strain in the fiber may be corrected (equations 1-5) or weighted for intensity differences due to strain field misalignment, which may be quantified as the magnitude of the resolved strain vectors. Referring to FIG. 6C, the strain signal attributed to strain field A would be assigned a lower weighting, confidence parameter, or higher correction factor than strain signal attributed to strain field B due to misalignment with the well path.

If a single helical fiber optic system is to be used, the wrap angle may be pre-selected prior to installation. The operator or analyst would decide which strain feature is most important to detect and should select a helical winding with a wrap angle that is best aligned with the strain field.

Alternatively, if multiple strain fields or a strain field with high level of orientation dispersion is expected, the single helical wrap angle may be selected to optimize coverage.

To increase orientation coverage, multiple helical wrap angles may be used, comprising a contra-helical fiber optic system.

To further increase orientation coverage, additional contra-helical fibers may be added with different wrap angles.

The method may be used to select a fiber pattern to be used, including optimization of the selected fiber pattern. In all cases, recorded strain may be corrected or weighted for intensity differences due to strain field misalignment.

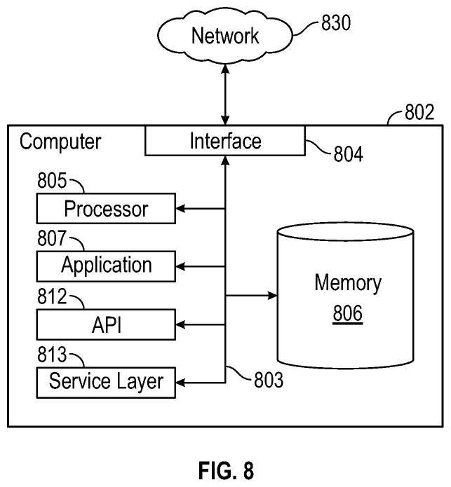

One or more blocks in FIG. 7 may be performed by a computer system as described in FIG. 8. While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 702, an expected source mechanism may be determined for the strain to be detected. The expected source mechanism may be based on a hypothesis that an operator has about the existing strain field to be measured. Very different source mechanisms may be assumed. For example, a strain field associated with fluid flow in a pipe is very different from a strain field associated with a hydraulic fracture. The strains associated with a source mechanism observed in subterranean regions may be finite, frequently large strains rather than negligible or infinitesimal strains. These finite strains are an accumulation of all the incremental infinitesimal strains over the deformation history of the subterranean region. The source mechanism that is to be detected by the fiber optic network using low-frequency DAS data may be determined using lab experiments, field reconnaissance methods, published data, computer simulations, or may be based on assumptions. Examples include, but are not limited to regional geological measurements such as satellite data (e.g., InSAR), downhole measurements such as wellbore based strain gauges, computed from geomechanical modeling (e.g., finite element or boundary element solutions), using field stress measurements (e.g., earthquake focal mechanisms, wellbore breakouts, pump-in tests, log-based stress models), and estimates using predictive kinematic models (strain-based models for faulting). The strain field may also be predicted from a mathematical model such as a geomechanical forward model, and the strain vector fields from these types of simulation could be used as a substitute for detailed field data. A source mechanism associated with the strain field may be a hydraulic fracture, subsidence, fault zone motion, tectonic deformation, caprock deformation during CO₂ injection, etc. In one or more embodiments, the strain field associated with the source mechanism is expected to be quasi-static, i.e., reflecting geomechanical deformation rather than acoustic wave propagation.

In Block 704, based on the expected source mechanism, the present-day three-dimensional strain field tensors s in the area of interest are estimated. A quantitative prediction may be performed (e.g., based on an analytical solution, simulation using any of the previously mentioned models, etc.). If estimated correctly, the estimated strain field reflects the true spatial and temporal heterogeneity in the area of interest. Subsequently the strain field may be simplified to a representative mean, median, or mode tensor. In this case, the strain field may be represented as a single term. Alternatively, multiple strain field tensors may be considered. In one or more embodiments, the wellbore and fiber optic network to be optimized are assumed to intersect the anticipated strain field.

In Block 706, using the strain field tensors, the principal strain vectors are determined. Specifically, the eigenvalues of the strain tensors may be computed to obtain the orientation and magnitude of the three principal strain vectors. For the subsequently discussed operations, the quantity of interest is the most extensional (or least contractional) principal strain, ε₃.

In Block 708, the ε₃ vectors that may potentially be encountered by the fiber optic system are stored, e.g., in a file or database. The ε₃ vectors may be for a representative wellbore transect, a two-dimensional cross-section, a three-dimensional cube, a four-dimensional volume with vectors that change spatially and with time, etc.

In Block 710, the statistical characteristics of the ε₃ vectors are determined. For example, it may be determined whether the ε₃ vectors follow a normal distribution, a gaussian distribution, or have some other form of heterogeneity. Histograms and/or stereonet displays may be used to determine and/or visualize the statistical characteristics. Other statistical approaches including machine learning and computer-assisted parameterization may be used, without departing from the disclosure.

In Block 712, the trajectory of the fiber optic path is established. Analytical or graphical methods may be used to compute the fiber optic path. For example, the fiber configuration may be plotted in a three-dimensional geometric and/or on a stereonet. The computation may be performed for different types of fiber configurations:
a. Linear fiber paths that run parallel to the wellbore and may be deployed in a range of ways. The computation may involve optimization of the direction vector of the fiber.
b. Helical fiber paths that spiral or twist around the wellbore axis. The computation may involve optimization of the three-dimensional fiber paths.
c. Contra-helical fiber paths commonly are wound around additional liner or sheath layers. Multiple layers may be used for multiple contra-helical patterns. The computation may involve optimization of the three-dimensional fiber paths.

In Block 714, the fiber path(s) is discretized and converted to directional vectors, εₐ. The unit vectors representing the fiber path(s) denote the direction of fiber axial strain εₐ.

In Block 716, the fiber directional vectors, εₐ, are compared against the strain field vectors, ε₃, to determine the optimal alignment in the next step. Different analytical and/or graphical methods may be used to determine optimal alignment. For example, the fiber direction vectors may be directly overlaid on the strain field vectors using a stereonet or another form of histogram. The fit may be visually or statistically determined. For the stereonet approach the fiber direction vectors, Ea, may be visualized as single points or lines (e.g., FIG. 4C, left panel) or as a statistical function such as the axial strain orientation coverage using a contour density function (e.g., FIG. 4C, right panel). The histograms of the vector components for the fiber direction and the strain field may be overlaid, and the alignment between the vector components for the fiber direction and strain field may be assessed qualitatively by visual inspection or quantitatively.

In Block 718, the alignment between fiber axial strain sa direction and field strain ε₃ is optimized, based on the comparison of Block 716. The optimization may be performed by changing the original design of the fiber path, as established by the operations of Block 712. The optimization may involve selecting the optimal fiber winding pattern, including the number of contra-helical fiber layers, the wrap angle for each layer, the total length of the fiber, etc. The optimization may consider various factors, including but not limited to the helical fiber angular sensitivity, S, (equation 8) and component strain-induced wavelength shift (equation 9). In other embodiments the strain vector optimization may also factor in network specifications such as fiber length and cost, gauge length, the type of coupling to the environment (e.g., cemented) and optical characteristics such as the refraction of the glass, backscattering properties, etc. The optimization may be performed using any optimization method such as regression analysis, machine learning, or other fitness optimization techniques.

In Block 720, corrections that may be used for remaining portions of the strain field that are oblique to the fiber path are determined. The corrections may involve weighting factors to adjust for misaligned orientations, that are under-sampled or under-resolved along the fiber cable. For example, the contra-helical fiber may be optimized to detect opening mode crack motion (dilation and closure) from hydraulic fractures oriented perpendicular to the wellbore. However, simultaneously existing hydraulic fractures intersecting the wellbore at oblique angles may be under-resolved by the selected fiber path, in which case a correction either to the strain field magnitudes (equations 1-5) or to the fiber signal amplitude may need to be applied in order to redistribute the weighting of detected strain along the wellbore. In another example, use of contra-helical fiber networks to detect fault motion during reservoir operations may result in optimal fiber orientation for detecting strike slip motions but fiber misalignment for resolving normal dip slip motion. The present methodology allows for quantification and correction due to the strain fields encountered by different faulting modes.

The method as described may be iteratively performed, i.e., the optimization may continue until an acceptable result is achieved.

In Block 722, a fiber optic sensing system is manufactured based on the parameters identified using the optimization as described. The fiber optic sensing system may come in different forms. For example, the fiber optic system may include a plug (e.g., extracted from rock core and used for laboratory testing) supporting one or more layers of coiled fiber. In another example, the fiber optic system may include a pipe that supports one or more layers of coiled fiber. The pipe may have any length, depending on the type of strain field to be measured. For example, a 10 m segment may be used to measure casing shear.

In Block 724, the fiber optic system is deployed. Deployment may depend on the specific type of fiber optic sensing system. For example, a plug may be inserted, a pipe section may be installed, etc. Measurements may then be performed, and the measurements may be processed, according to the optimization results obtained by the method of described. For example, measurement results may be corrected using the corrections obtained in Block 720.

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or other suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804 includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A method for measuring a strain field, the method comprising:
determining an expected source mechanism of the strain field;
based on the expected source mechanism, estimating strain field tensors of the strain field in an area of interest;
determining principal strain vectors from the strain field tensors;
identifying the most extensional principal strain vectors, ε₃, from the principal strain vectors;
establishing a trajectory of a fiber optic path through the area of interest;
discretizing the fiber optic path to obtain directions of fiber axial strain, εₐ;
comparing εₐ against ε₃; and
based on the comparison, optimizing the fiber optic path for an alignment of εₐ with ε₃.

2. The method of claim 1, further comprising:
determining corrections to misaligned orientations of ε₃ against εₐ.

3. The method of claim 1, further comprising:
manufacturing a fiber optic system based on the optimized fiber optic path.

4. The method of claim 3,
wherein the fiber optic system comprises one selected from a group consisting of a plug and a pipe supporting one or more layers of fiber coiled according to the optimized fiber optic path.

5. The method of claim 3, further comprising:
deploying the fiber optic system to measure the strain field in the area of interest.

6. The method of claim 1, wherein determining the expected source mechanism of the strain field comprises:
receiving the expected source mechanism from an operator.

7. The method of claim 1, wherein estimating the strain field tensors of the strain field in the area of interest comprises one selected from a group consisting of:
obtaining an analytical solution for the expected source mechanism of the strain field, and
executing a simulation model for the expected source mechanism of the strain field.

8. The method of claim 1, wherein determining the principal strain vectors from the strain field tensors comprises:
computing the eigenvalues of the strain field tensors.

9. The method of claim 1, wherein the trajectory of the fiber optic path through the area of interest is one selected from a group consisting of:
a linear fiber optic path,
a helical fiber path, and
a contra-helical fiber path.

10. The method of claim 1, wherein discretizing the fiber optic path to obtain directions of fiber axial strain, εₐ comprises:
quantifying an orientation of the fiber optic path using unit vectors representing a tangential direction of the fiber optic path average over a gauge length of a fiber associated with the fiber optic path.

11. The method of claim 1, wherein comparing εₐ against ε₃ comprises:
generating a histogram for a distribution of ε₃.

12. The method of claim 1, wherein optimizing the fiber optic path for an alignment of εₐ with ε₃ comprises at least one selected from a group consisting of:
adjusting a wrap angle of the fiber optic path of a helical fiber,
adjusting a number of fibers on the fiber optic path, and
adjusting a length of a fiber on the fiber optic path.

13. The method of claim 1, wherein optimizing the fiber optic path for an alignment of Ea with ε₃ comprises one selected from a group consisting of:
a regression analysis, and
machine learning.

14. The method of claim 1, further comprising:
determining statistical characteristics of ε₃,
wherein the optimizing the fiber optic path for an alignment of εₐ with ε₃ is performed using the statistical characteristics of ε₃.

15. A system for measuring a strain field, the system comprising:
a computer system configured to:
determine an expected source mechanism of the strain field;
based on the expected source mechanism, estimate strain field tensors of the strain field in an area of interest;
determine principal strain vectors from the strain field tensors;
identify the most extensional principal strain vectors, ε₃, from the principal strain vectors;
establish a trajectory of a fiber optic path through the area of interest;
discretize the fiber optic path to obtain directions of fiber axial strain, εₐ;
compare εₐ against ε₃; and
based on the comparison, optimize the fiber optic path for an alignment of εₐ with ε₃.

16. The system of claim 15, wherein estimating the strain field tensors of the strain field in the area of interest comprises one selected from a group consisting of:
obtaining an analytical solution for the expected source mechanism of the strain field, and
executing a simulation model for the expected source mechanism of the strain field.

17. The system of claim 15, wherein the trajectory of the fiber optic path through the area of interest is one selected from a group consisting of:
a linear fiber optic path,
a helical fiber path, and
a contra-helical fiber path.

18. The system of claim 15, wherein discretizing the fiber optic path to obtain directions of fiber axial strain, εₐ comprises:
quantifying an orientation of the fiber optic path using unit vectors representing a tangential direction of the fiber optic path average over a gauge length of a fiber associated with the fiber optic path.

19. The system of claim 15, wherein optimizing the fiber optic path for an alignment of εₐ with ε₃ comprises at least one selected from a group consisting of:
adjusting a wrap angle of the fiber optic path of a helical fiber, adjusting a number of fibers on the fiber optic path, and
adjusting a length of a fiber on the fiber optic path.

20. A non-transitory machine-readable medium comprising a plurality of machine-readable instructions executed by one or more processors, the plurality of machine-readable instructions causing the one or more processors to perform operations comprising:
determining an expected source mechanism of a strain field;
based on the expected source mechanism, estimating strain field tensors of the strain field in an area of interest;
determining principal strain vectors from the strain field tensors;
identifying the most extensional principal strain vectors, ε₃, from the principal strain vectors;
establishing a trajectory of a fiber optic path through the area of interest;
discretizing the fiber optic path to obtain directions of fiber axial strain, εₐ;
comparing εₐ against ε₃; and
based on the comparison, optimizing the fiber optic path for an alignment of εₐ with ε₃.
